(19) United States
(12) Patent Application Publication
(10) Pub. No.: US 2015/0170162 A1
(43) Pub. Date: Jun. 18, 2015

(54) COMPUTER-BASED INFERENCE OF INCONVENIENT TRAVELER EXPERIENCES FOR PRODUCTS AND SERVICES

(71) Applicant: INTERNATIONAL BUSINESS MACHINES CORPORATION, ARMONK, NY (US)

(72) Inventors: Michele Berlingerio, Noicattaro (IE); Adi lonel Botea, Dublin (IE); Eric Bouillet, Dublin (IE); Francesco Calabrese, Dublin (IE); Fabio Pinelli, Dublin (IE)

(73) Assignee: INTERNATIONAL BUSINESS MACHINES CORPORATION, ARMONK, NY (US)

(21) Appl. No.: 14/105,016

(22) Filed: Dec. 12, 2013

(51) Int. Cl. G06Q 30/02; G06Q 50/30

(52) U.S. Cl. CPC G06Q 30/0201; G06Q 50/30

(57) ABSTRACT

A method for inferring inconvenient travel experiences may include analyzing, with a processing device, a record of a displacement of a traveler, detecting a traveler displacement pattern indicative of a potential inconvenience, verifying a transport network status corresponding to the potential inconvenience, and validating an inferred inconvenience based on the potential inconvenience and the transport network status.

### BACKGROUND

The present invention relates generally to data analysis, and more specifically, to analyzing data to infer inconvenient experiences encountered by travelers during a journey.

Travelers sometimes encounter inconvenient experiences during their journey, such as missed transportation connections, failed attempts to rent a car or a bicycle, inability to hire a taxi, extensive searches for a parking space, long waiting times, and the like. Systems and methods are available to automatically detect the transport mode or the actual vehicle utilized by a traveler, points of origin and destination of a journey, and switching points where a traveler changes transport network or vehicle during a journey. Systems and methods also are available to analyze cancelled flights and missed connections in air travel where the traveler's original journey plans are known.

### SUMMARY

According to one embodiment of the present invention, a method for inferring inconvenient travel experiences includes analyzing, with a processing device, a record of a displacement of a traveler, detecting a traveler displacement pattern indicative of a potential inconvenience, verifying a transport network status corresponding to the potential inconvenience, and validating an inferred inconvenience based on the potential inconvenience and the transport network status.

According to another embodiment of the present invention, a system for inferring inconvenient travel experiences includes an inconvenient experience identifier configured to analyze a record of a displacement of a traveler and detect a traveler displacement pattern indicative of a potential inconvenience, and an inconvenient experience validator configured to verify a transport network status corresponding to the potential inconvenience and validate an inferred inconvenience based on the potential inconvenience and the transport network status.

According to yet another embodiment of the present invention, a computer program product for inferring inconvenient travel experiences includes a computer readable storage medium having program code embodied therewith, the program code executable by a computer to implement analyzing a record of a displacement of a traveler, detecting a traveler displacement pattern indicative of a potential inconvenience, verifying a transport network status corresponding to the potential inconvenience, and validating an inferred inconvenience based on the potential inconvenience and the transport network status.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic diagram of an apparatus in accordance with an embodiment of the invention.

FIG. 2 is a flow diagram of a method in accordance with an embodiment of the invention.

### DETAILED DESCRIPTION

An embodiment in accordance with the present invention may provide a method for automatically inferring inconvenient experiences encountered by a traveler during a journey. The method may include processing historical data about the location of one or more travelers during a time interval to identify potential inconvenient experiences. The method may further include processing data regarding the status of a multi-modal transport network during the time interval to verify the occurrence of the inconvenient experience.

Contemporary systems and methods do not detect desirable actions that were not realized or that were not fully successful. An embodiment of the present invention may infer knowledge about failed actions, such as missed connections, failed attempts to hire a vehicle, or failed attempts to find parking. An embodiment may infer this knowledge without receiving input regarding the traveler's original plans or intent.

An embodiment may convert raw data into a meaningful explanation of the travel experience. The knowledge inferred by an embodiment may provide valuable information that may be utilized to optimize a multi-modal transport network. For example, the information may be applied to reduce the number of missed connections or to reduce long waiting times. Information regarding the number of people that miss a particular connection may be used in the design of public transport vehicle schedules. Similarly, information about the number of people who are unable to find an available bicycle at a particular location may be used to determine the distribution of bicycles for a shared bicycle network.

The knowledge inferred by an embodiment may further be utilized in the design and planning of a multi-modal transport network. For example, the capacity of a bicycle station may be adjusted based on the frequency with which individual travelers are unable to find an available bicycle or parking space at the station. In addition, knowledge inferred by an embodiment regarding the probability of success of a particular mode or action may be used as a decision criterion by travelers in journey planning. Furthermore, increased accuracy in assessments of overall user satisfaction and experience by an embodiment may play a key role in the analysis of traveler satisfaction analysis.

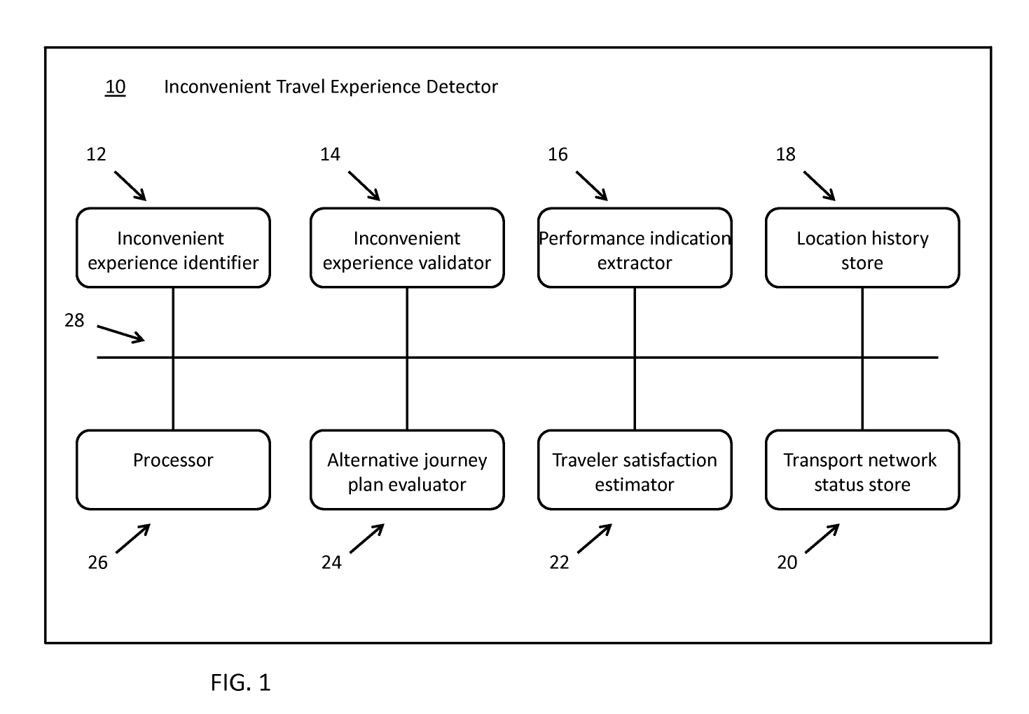

With reference now to FIG. 1, an inconvenient travel experience detector 10 may include an inconvenient experience identifier 12, an inconvenient experience validator 14, a performance indication extractor 16, a location history store 18, a transport network status store 20, a traveler satisfaction estimator 22, an alternative journey plan evaluator 24, and a processor 26, all of which may be communicatively connected by data links 28.

The data links 28 may include any connective medium capable of transmitting analog or digital data, as the specific application may require. For example, in any embodiment, the data links 28 may be implemented using any type of combination of known communications connections, including but not limited to digital data buses, a universal serial bus (USB), an Ethernet bus or cable, a wireless access point, twisted pairs of wires, or the like. In any embodiment, any portion or all of the data links 28 may be implemented using physical connections, radio frequency or wireless technology. A person of ordinary skill in the art will readily apprehend that any combination of numerous existing or future data communication technologies may be implemented in association with an embodiment of the invention.

The inconvenient experience identifier 12 may be configured to receive, as input, historical data regarding the location of one or more travelers over a period of time. For example, historical location data may be stored in and received from the location history store 18. The location history store 18 may include any type of computer memory medium organized in any format, such as, for example, a relational model database server, a hierarchical database, an information management system, a virtual storage access method server, a hard disk drive (HDD), a magnetic tape, a disk drive, a compact disk (CD) drive, an integral or removable solid-state drive (SSD), or any other suitable memory medium known in the art.

In an embodiment, the historical location data may include a traveler mobility trace, for example, formatted as a sequence of journey legs. For example, the mobility trace may include a trip record, journey reconstruction, journey legs or transport modes, such as the traveler riding a public transport vehicle, waiting at a given location, walking, cycling, renting a bicycle, hiring a vehicle, parking a vehicle, or the like. The trace may further include timing details, such as time stamps, including, for example, the start, end and duration of each journey leg, or action. The trace may include the speed of the vehicle.

The inconvenient experience identifier 12 may analyze the historical location data, for example, implementing data mining techniques known in the art, to identify potential inconvenient experiences encountered by a traveler. The inconvenient experience identifier 12 may identify specific spatio-temporal properties of a trace. The inconvenient experience identifier 12 may identify inconveniently long waiting times according to a function that decides between acceptable and inconveniently long waiting times.

For example, in an embodiment, the inconvenient experience identifier 12 may receive location data regarding a traveler. The location data, or traveler trace, may correspond, for example, to one day during a journey. The inconvenient experience identifier 12 may analyze the location data and determine that the trace indicates that at a particular time during the day the traveler cycled to and slowed down, or even briefly stopped, a particular bikeshare station, after which he cycled away to another bike-share station. The inconvenient experience identifier 12 may identify this action as a potential inconvenient experience, specifically, a failed attempt to park a bicycle at the first station.

The inconvenient experience validator 14 may be configured to receive historical data regarding the status of a multi-modal transport network over the same time period or an overlapping time interval. For example, historical transport network data may be stored in and received from the transport network status store 20. The transport network status store 20 may include any type of computer memory medium organized in any format, such as, for example, a relational model database server, a hierarchical database, an information management system, a virtual storage access method server, a hard disk drive (HDD), a magnetic tape, a disk drive, a compact disk (CD) drive, an integral or removable solid-state drive (SSD), or any other suitable memory medium known in the art.

The inconvenient experience validator 14 may analyze the historical transport network data, for example, implementing data mining techniques known in the art, to identify corroborating data that may verify, or validate, the probability of the actual occurrence of the experiences to create a set of inferred inconvenient experiences. That is, once a candidate inconvenient experience has been detected by the inconvenient experience identifier 12, the inconvenient experience validator 14 may further check the status of the multi-modal transportation network to decide if the candidate occurrence should be considered an inconvenient experience.

For example, in an embodiment, the inconvenient experience validator 14 may receive transport network data regarding the shared bicycle network. The transport network data may include, for example, snapshots of data regarding bicycle availability across a time interval corresponding to at least a portion of the day during the traveler's journey including the particular time at which the traveler had slowed or stopped at the first bike-share station.

The inconvenient experience validator 14 may analyze, or query, the transport network data regarding to check whether or not the station had any available bicycle stalls at the time the traveler was present. If no bicycle stalls were available, the inconvenient experience validator 14 may determine that an inconvenient experience did occur and record the traveler's failed attempt to park the bicycle at the first station as an inferred inconvenient experience.

The inconvenient experience validator 14 may provide a listing of all inferred inconvenient experiences, for example, for a traveler or multiple travelers corresponding to a specific time period, along with the corresponding time information, locations, and descriptions. Inconvenient experiences may include, for example, failed attempts to hire or park a vehicle, such as an automobile or a bicycle, missed transit connections, excessive waiting times to park a vehicle, or the like.

The performance indication extractor 16 may be configured to aggregate inferred inconvenient experiences having a similar spatio-temporal pattern and to extract key performance indicators (KPIs) regarding the inferred inconvenient experiences, such as statistics about not finding a parking spot at a given bike station within a given time interval of the day. For example, the performance indication extractor 16 may aggregate the inferred inconvenient experiences, along with the corresponding time information, locations, and descriptions, in chronological order. The performance indication extractor 16 may perform statistical analysis on the list of inconvenient experiences and identify key performance indicators.

For example, in an embodiment, the performance indication extractor 16 may compute a key performance indicator regarding the first bike-share station quantifying the number of people unable to park at the first station within a given time interval.

The traveler satisfaction estimator 22 may be configured to assess user satisfaction of the traveler, for example, based on the traveler's inferred experiences during a journey. The alternative journey plan evaluator 24 may be configured to evaluate information about the probability of inconvenient experiences in a journey planning system to establish a preference regarding one plan over another, optimizing a multi-modal transportation network, or planning changes or extensions to a multi-modal transportation network.

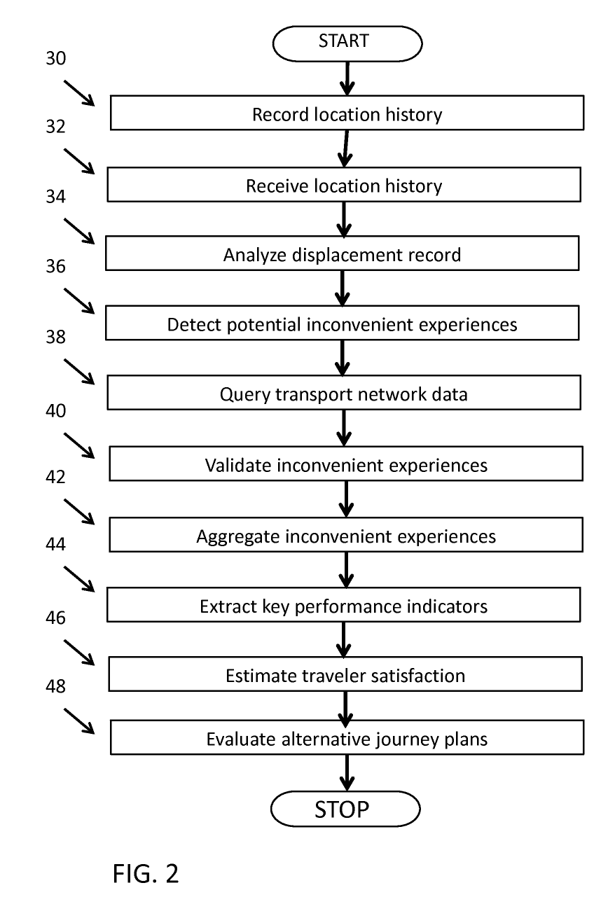

Referring now to FIG. 2, a method in accordance with the present invention is generally shown. In block 30, the location history of a traveler may be recorded. For example, a time-series of traveler locations may be traced from the traveler's mobile telephone global positioning system (GPS) data or triangulated location data based on cellular telephone broadcast signals. In an embodiment, for example, an application installed in the traveler's mobile phone memory and executed by the mobile phone processor may trace the location history. In an alternative embodiment, for example, periodic location data may be sent from the traveler's mobile phone, or other GPS-enabled device, to a remote server that may trace the traveler's location history.

In block 32, the traveler's location history may be received, for example, from a location history database stored in the traveler's mobile telephone memory or in a remote server. The traveler's location history may be analyzed, in block 34, for example, to derive a displacement sequence reflecting the traveler's movements or actions. The traveler's displacement sequence may be further analyzed, in block 36, to detect displacement patterns that may indicate potential inconvenient experiences. For example, traveler traces may be mined to identify sequences of actions or displacement patterns indicating that a traveler walked from a location to a bike station, stopped at the bike station for a brief period, and then walked away to another location. Each such displacement pattern may be recorded as a potential inconvenient experience.

In block 38, data regarding a transport network related to the traveler's movements or actions may be queried. For example, the displacement pattern above may trigger a look-up in a network knowledge base verify the number of bicycles available at the bike station at the time the traveler was present. The inconvenient experience may be validated in block 40. For example, if no bicycles were available at the bike station during the period of time the traveler was at the bike station, then the potential inconvenient experience may be validated and recorded as an inferred inconvenient experience, specifically, as a failed attempt to hire a bicycle.

In various embodiments, additional conditions may be considered to characterize inconvenient experiences. For example, the path taken by a traveler walking between the two locations in the above example may be compared to an optimal path between the two points. A suboptimal path, outside a certain tolerance, would provide additional validation that the traveler intended to hire a bicycle at the bike station, explaining the detour to the bike station.

In an embodiment, an inconvenient experience may include a failed attempt to catch a public transport connection, such as an airline, train or bus connection. For example, an embodiment may identify travelers that wait at a bus station before a particular bus arrives, but do not board the bus after it arrives. An embodiment may verify that boarding the bus would have been a useful action in pursuing the destination of each traveler, for example, by identifying the destination of each traveler from their location history and checking whether boarding the bus would have resulted in an improved journey plan.

In block 40, inconvenient experiences, for example, regarding a particular location or transport network, may be aggregated over time. Key performance indicators may extracted from the aggregate inconvenient experiences, in block 42, and used, for example, to optimize the transit network, schedule or other services offered by the cities.

Traveler satisfaction may be estimated, in block 46, for example, based on the traveler's inferred experiences during the journey. The aggregate inferred experiences of travelers may be used to evaluate alternative journey plans, in block 48, for example, to determine a preference for one alternative with respect to the other alternatives.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for inferring inconvenient travel experiences, comprising:
analyzing, with a processing device, a record of a displacement of a traveler;
detecting a traveler displacement pattern indicative of a potential inconvenience;
verifying a transport network status corresponding to the potential inconvenience; and
validating an inferred inconvenience based on the potential inconvenience and the transport network status.

2. The method of claim 1, further comprising:
tracing a sequence of locations of the traveler during a time period; and
storing the sequence, wherein the displacement is derived from the sequence.

3. The method of claim 1, wherein verifying the transport network status further comprises querying a database associated with the transport network regarding the transport network status corresponding to the potential inconvenience.

4. The method of claim 1, further comprising:
aggregating a plurality of inferred inconveniences corresponding to the transport network; and
extracting a performance indication based on the aggregate inferred inconveniences.

5. The method of claim 1, further comprising storing status information associated with a plurality of transport networks.

6. The method of claim 1, wherein the traveler displacement pattern is indicative of a failed attempt to hire a vehicle, a failed attempt to park a vehicle, or a missed transport connection.

7. The method of claim 1, wherein the traveler displacement pattern is indicative of an excessive waiting time associated with a transport connection, hiring a vehicle, or parking a vehicle.

8. The method of claim 1, further comprising estimating a satisfaction level of the traveler based at least in part on the inferred inconvenience.

9. The method of claim 1, further comprising:
evaluating a plurality of alternative journey plans; and
determining a preference for a journey plan based on a probability of an inconvenient experience.

10. A system for inferring inconvenient travel experiences, comprising:
an inconvenient experience identifier configured to analyze a record of a displacement of a traveler and detect a traveler displacement pattern indicative of a potential inconvenience; and
an inconvenient experience validator configured to verify a transport network status corresponding to the potential inconvenience and validate an inferred inconvenience based on the potential inconvenience and the transport network status.

11. The system of claim 10, further comprising a location history store configured to store a sequence of locations of the traveler during a time period, wherein the displacement is derived from the sequence.

12. The system of claim 10, wherein the inconvenient experience validator is further configured to query a database associated with the transport network regarding the transport network status corresponding to the potential inconvenience.

13. The system of claim 10, further comprising a performance indication extractor configured to aggregate a plurality of inferred inconveniences corresponding to the transport network and extract a performance indication based on the aggregate inferred inconveniences.

14. The system of claim 10, further comprising a transport network status store configured to store status information associated with a plurality of transport networks.

15. The system of claim 10, further comprising a traveler satisfaction estimator configured to estimate a satisfaction level of the traveler based at least in part on the inferred inconvenience.

16. The system of claim 10, further comprising an alternative journey plan evaluator configured to evaluate a plurality of alternative journey plans and determine a preference for a journey plan based on a probability of an inconvenient experience.

17. A computer program product for inferring inconvenient travel experiences, the computer program product comprising:
a computer readable storage medium having program code embodied therewith, the program code executable by a computer to implement:
analyzing a record of a displacement of a traveler;
detecting a traveler displacement pattern indicative of a potential inconvenience;
verifying a transport network status corresponding to the potential inconvenience; and
validating an inferred inconvenience based on the potential inconvenience and the transport network status.

18. The computer program product of claim 17, the program code being further executable by a computer to implement:
aggregating a plurality of inferred inconveniences corresponding to the transport network; and
extracting a performance indication based on the aggregate inferred inconveniences.

19. The computer program product of claim 17, the program code being further executable by a computer to implement estimating a satisfaction level of the traveler based at least in part on the inferred inconvenience

20. The computer program product of claim 17, the program code being further executable by a computer to implement optimizing a transport network based on a probability of an inconvenient experience.
